(19) United States
(12) Patent Application Publication
(10) Pub. No.: US 2012/0010331 A1
(43) Pub. Date: Jan. 12, 2012

(54) CONCRETE COMPOSITIONS USING BLAST-FURNACE SLAG COMPOSITIONS

(75) Inventors: Toshio Yonezawa, Inzai (JP); Kenro Mitsui, Inzai (JP); Kazumasa Inoue, Inzai (JP); Yosaku Ikeo, Inzai (JP); Masahiro Wachi, Inzai (JP); Takashi Hasumi, Inzai (JP); Mitsuo Kinoshita, Gamagori (JP); Kazuhide Saitou, Gamagori (JP); Moe Kuroda, Gamagori (JP); Shinji Tamaki, Gamagori (JP)

(73) Assignee: TAKEMOTO YUSHI KABUSHIKI KAISHA, Gamagori (JP)

(21) Appl. No.: 13/234,537

(22) Filed: Sep. 16, 2011

Related U.S. Application Data
(63) Continuation of application No. PCT/JP2010/059698, filed on Jun. 8, 2010.

(30) Foreign Application Priority Data
Jun. 9, 2009 (JP) 2009-137983

(51) Int. Cl. C08K 3/00; C04B 7/19; C04B 28/08

(52) U.S. Cl. 524/5; 106/789; 106/715

(57) ABSTRACT

Concrete compositions including a binder, water, a fine aggregate, a coarse aggregate and an admixture are provided. The binder is formed with a blast-furnace slag composition including 100 mass parts of a mixture of 80-95 mass % of blast-furnace slag fine particles with fineness 3000-13000 cm²/g and 5-20 mass parts of gypsum for a total of 100 mass % and 0.5-1.5 mass parts or 5-45 mass parts of an alkaline stimulant. Such concrete compositions can maintain superior operability by reducing the discharged amount of carbon dioxide and the decrease with time in fluidity and air content of the prepared concrete compositions. They can also reduce the drying shrinkage of the obtained hardened objects and allow the obtained hardened objects to manifest necessary strength.

This application is a continuation of International Application No. PCT/JP2010/059698, filed Jun. 8, 2010, priority being claimed on Japanese Patent Application 2009-137983 filed Jun. 9, 2009.

### BACKGROUND OF THE INVENTION

This invention relates to concrete compositions using blast-furnace slag compositions. In recent years, the demand for reducing the emission rate of carbon dioxide and improving efficient energy consumption is becoming increasingly stronger. Under this condition, blast-furnace slag as by-product from steel mills is being effectively used as material for blast-furnace slag cement in the form of blast-furnace slag fine particles. Generally, blast-furnace slag cement of the type usually used for concrete compositions is produced by mixing blast-furnace slag fine particles into normal portland cement and is divided according to the JIS-R5211 standard into the following three kinds, depending on the amount of the blast-furnace slag fine particles: Type A (over 5% to 30%), Type B (over 30% to 60%) and Type C (over 60% to 70%). These kinds of blast-furnace slag cement have advantageous characteristics such as low heat of hydration, large extension of long-term strength, large water-tightness, high resistance against chemical erosion by sulfates and inhibitive effects against alkali aggregate reaction but they also possess problems such that shrinkage upon drying is relatively large compared to portland cement and that hardened objects obtained from concrete compositions using blast-furnace slag cement tend to develop shrinkage cracks, as well as disadvantages such that they degenerate quickly by neutralization as compared to portland cement. For these reasons, the present situation is that the use of blast-furnace slag cement is limited only to Type B with a good balance in characteristics but Type B blast-furnace slag cement is usually mixed at the rate of 250-450 kg per 1 m³ of concrete. Since about 400 kg of carbon dioxide is emitted for producing 1 ton of Type B blast-furnace slag cement at a factory, this means that 100-180 kg of carbon dioxide is emitted for producing 1 m³ of concrete by using Type B blast-furnace slag cement, exclusive of the emission of carbon dioxide generated by the operation of construction machines, transportation of materials, etc. For this reason, in the field of concrete work, there have been demands for the development of technology for suppressing the generation of carbon dioxide by using blast-furnace slag cement at a higher rate, while maintaining operability and the prerequisite that the hardened obtained objects will have the necessary strength.

The present invention relates to concrete compositions using blast-furnace slag cement that can respond to such demands.

There have been reports on the effects of fineness and replacement ratio of blast-furnace slag fine particles to be used on the obtained concrete composition such as “Present Status of Concrete Technology Using Blast-Furnace Slag Fine Particles”, by Japan Architecture Institute (1992), page 3. It is reported therein that if the amount of blast-furnace slag fine particles used is increased with respect to normal portland cement, disadvantageous material characteristics of concrete such that the initial strength becomes lower, the neutralization becomes quicker and the drying shrinkage becomes greater become prominent as compared with situations where normal portland cement is used alone. Besides the above, there have been several proposals on the use of admixtures of various kinds in addition to such blast-furnace slag fine particles such as Japanese Patent Publications Tokkai 62-158146, 63-2842, 1-167267, 10-114555, 2000-143326, 2003-306359, 2005-281123, 2007-217197, and 2007-297226. These prior art proposals are all problematical in that good operability cannot be maintained, the drying shrinkage ratio cannot be controlled easily and the compressive strength of the hardened objects drops to a large degree as the amount of blast-furnace slag fine particles to be used is increased.

### SUMMARY OF THE INVENTION

It is therefore an object of this invention to provide concrete compositions having all three of the following basic characteristics as the amount of blast-furnace slag fine particles to be used is increased to control the emission of carbon dioxide; (1) ability to maintain good operability by controlling the decrease with time in the fluidity and air content of the prepared concrete composition; (2) ability to prevent the drying shrinkage ratio of the obtained hardened object from becoming large compared to the situation where Type B blast-furnace slag cement is used; and (3) ability to allow the obtained hardened object to exhibit necessary strength.

The inventors herein have discovered as a result of their diligent studies in view of the aforementioned object of the present invention that concrete compositions containing blast-furnace slag fine particles as the binder (or bonding agent) at a high rate and also using a blast-furnace slag composition of a specified kind containing gypsum and an alkaline stimulant together with an admixture are correctly responsive to the object of the present invention.

### DETAILED DESCRIPTION OF THE INVENTION

The present invention relates to concrete compositions comprised at least of a binder, water, a fine aggregate, a coarse aggregate and an admixture, wherein the binder is a blast-furnace slag composition having 0.5-1.5 mass parts or 5-45 mass parts of an alkaline stimulant added to 100 mass parts of a mixture containing blast-furnace slag fine particles of fineness 3000-13000 cm²/g at a rate of 80-95 mass % and gypsum at a rate of 5-20 mass % for a total of 100 mass % and the mass ratio of water/blast-furnace slag composition is adjusted to 30-60%.

Concrete compositions using blast-furnace slag compositions according to this invention (hereinafter referred to as concrete compositions of this invention) are characterized as comprising at least a binder, water, a fine aggregate, a coarse aggregate and an admixture, wherein the binder is characterized as using a blast-furnace slag composition of a specified kind having 0.5-1.5 mass parts or 5-45 mass parts of an alkaline stimulant added to 100 mass parts of a mixture containing blast-furnace slag fine particles of fineness 3000-13000 cm²/g at a rate of 80-95 mass % and gypsum at a rate of 5-20 mass % for a total of 100 mass %.

As the aforementioned blast-furnace slag fine particles, those with fineness 3000-13000 cm²/g are used but it is preferable to use those with fineness 3000-8000 cm²/g and even more preferable to use those with fineness 3500-6500 cm²/g. If those not within the range of 3000-13000 cm²/g are used, fluidity of the prepared concrete composition may be poor or manifested strength of the obtained hardened object may be lowered. Throughout herein, fineness of particles will be values obtained by the blain method expressed in terms of the specific surface area.

Gypsum may be anhydrous gypsum, gypsum dihydrate or gypsum semihydrate but anhydrous gypsum is preferable. As anhydrous gypsum, anything that contains it with purity of 90 mass % or above may be used, inclusive of natural anhydrous gypsum and anhydrous gypsum obtained as a by-product. Those with fineness 3000-8000 cm²/g are preferable and those with fineness 3500-6500 cm²/g are even more preferable.

Examples of alkaline stimulant that may be used include calcium hydroxide, lime, light burnt magnesia, light burnt dolomite, sodium hydroxide and sodium carbonate. For the purpose of the present invention in particular, such alkaline stimulants with the property of gradually generating calcium hydroxide when contacting water are preferable. Portland cement is most preferable as alkaline stimulant having such property. Examples of portland cement include all kinds of portland cement such as normal portland cement, high early strength portland cement and moderate heat portland cement, but multi-purpose normal portland cement is preferable.

As fine aggregate for the concrete compositions of this invention, river sands, crushed sands and mountain sands of known kinds may be used. As coarse aggregate, river gravels, crushed gravels and light-weight aggregates may be used.

For producing concrete compositions of this invention, the mass ratio between water and blast-furnace slag composition is adjusted to 30-60%, and more preferably to 35-55%. If this mass ratio is greater than 60%, the drying shrinkage of the obtained hardened object becomes too large or its strength drops prominently. If this mass ratio is smaller than 30%, on the other hand, the decrease in fluidity or air content of the prepared concrete composition becomes large and operability is adversely affected. Throughout herein the mass ratio between water and blast-furnace is understood to be the value obtained as {(mass of water that was used)/(mass of blast-furnace slag composition that was used)}×100.

For producing concrete compositions of this invention, any publicly known kind of admixture what is being used for the production of concrete may be used such as a cement dispersant, a drying shrinkage reducing agent and an expanding material. For producing concrete compositions of this invention, a cement dispersant and a drying shrinkage reducing agent, a cement dispersant and an expanding material or a cement dispersant, a drying shrinkage reducing agent and an expanding material may be used as admixture.

Examples of cement dispersant that may be used include lignin sulfonates, gluconates, naphthalene sulfonate formalin high condensate salts, melamine sulfonate formalin high condensate salts and water soluble polycarboxylic acid copolymers. Among these examples, water soluble polycarboxylic acid copolymers are preferable and those with appropriate kinds of structural units, composition ratios and molecular weights are particularly preferable. Examples of such particularly preferable water soluble carboxylic acid copolymer include copolymers having structural units formed of methacrylic acid (salts) (such as described in Japanese Patent Publications Tokkai 58-74552 and 1-226757) and copolymers having structural units formed of maleic acid (salts) (such as described in Japanese Patent Publications Tokkai 57-118058, 63-285140 and 2005-132956). Particularly preferable among the above as cement dispersant, however, are water soluble polycarboxylic acid copolymers having structural units formed of methacrylic acid (salts), and those having Structural Units A by 45-85 molar %, Structural Units B by 15-55 molar % and Structural Units C by 0-10 molar % in the molecule for a total of 100 molar % and having mass average molecular weight (hereinafter gel-permeation chromatography method, pullulan converted weight) of 2000-80000 are even more particularly preferable. In the above, Structural Units A are defined as one or more selected from structural units formed of methacrylic acid and structural units formed of salts of methacrylic acid; Structural Units B are defined as structural units formed of methoxy polyethylene glycol methacrylate having polyoxy ethylene group structured with 5-150 oxyethylene units within a molecule; and Structural Units C are defined as one or more selected from structural units formed of (meth)allyl sulfonic acid and structural units formed of methyl acrylate.

Cement dispersants comprising water soluble polycarboxylic acid copolymers as described above can be synthesized by any known method. In the case of copolymers having structural units formed of methacrylic acid (salts), they may be synthesized by methods described, for example, in Japanese Patent Publications Tokkai 58-74552 and 1-226757. In the case of copolymers having structural units formed of maleic acid (salts), they may be synthesized by methods described, for example, in Japanese Patent Publications Tokkai 57-118058, 2005-132956 and 2008-273766. The amount of cement dispersants comprising such water soluble carboxylic acid copolymers to be used is preferably 0.1-1.5 mass parts per 100 mass parts of blast-furnace slag compositions.

There is no particular limitation on the drying shrinkage reducing agent to be used but those comprising polyalkylene glycol monoalkylether are preferable and those selected from diethylene glycol monobutylether and dipropylene glycol diethylene glycol monobutylether are particularly preferable. Such drying shrinkage reducing agents are used preferably at the rate of 0.2-4.0 mass parts per 100 mass parts of blast-furnace slag composition.

Expansion materials of known kinds may be used and may be roughly divided into the two categories of the calcium sulfoaluminate type and the lime type. Both are inorganic expansion materials adapted to expand by generating ettringite and calcium hydroxide by an hydration reaction. Those satisfying the standard of JIS-A6202 are preferable as expansion material for concrete. Such expansion material is preferably used as a rate of 10-25 kg per 1 m³ of concrete composition.

An air-entraining (AE) agent may be used as supplementary agent when the concrete composition of the present invention is AE concrete normally entraining 3-6 volume % of air. There is no particular limitation on such air-entraining agent, and those of publicly known kinds may be used. Examples of publicly known AE agent that may be used include polyoxyalkylene alkylether sulfates, alkylbenzene sulfonates, polyoxyalkyl benzenesulfonates, rosin soap, higher aliphatic acid soap, alkyl phosphate ester salts and polyoxyalkylene alkylether phosphate salts. In situations where the air content becomes excessive when concrete compositions of this invention are prepared, on the other hand, a defoamer may be used singly or together with an air-entraining agent described above. There is no particular limitation on such defoamer, and those of known kinds may be used. A defoamer such as derivatives of polyoxyalkylene glycol ether, modified polydimethyl siloxane and trialkyl phosphate can be used. The amount of defoamer to be used is preferably 0.001-0.01 mass parts for 100 mass parts of blast-furnace slag composition.

Concrete compositions of this invention may be prepared by a known method but a method of carrying out dry mixing of a blast-furnace composition, water, fine aggregates and coarse aggregates in a mixer while appropriately mixing a cement dispersant, a drying shrinkage reducing agent, an expansion material and an air content adjusting agent described above together with kneading and diluting them with water, and thereafter mixing them together with kneading is preferable. When concrete compositions of this invention are prepared, additive agents such as a hardening accelerator, a setting retarder, a corrosion inhibitor, a waterproofing agent and an antiseptic may be added, if necessary, within the limit of not adversely affecting the effects of this invention.

With concrete compositions of this invention, the drying shrinkage ratio of the obtained hardened object becomes less than 800×10⁻⁶. Concrete compositions of this invention are useful not only for installation at a construction site but also for secondary products that are fabricated at a concrete production factory.

The present invention has the merit of making it possible not only to prepare concrete compositions while limiting the amount of discharged carbon dioxide and preventing the reduction in fluidity and air content of produced concrete compositions with time while maintaining operability but also to limit the drying shrinkage of obtained hardened objects and to allow the obtained hardened object to manifest necessary strength.

In what follows, the invention will be explained in terms of some examples but these examples are not intended to limit the scope of the invention. In the following examples, unless otherwise explained, “%” means “mass %”, and “parts” means “mass parts”.

### Part 1 (Synthesis of Water Soluble Carboxylic Acid Copolymers)

Synthesis of Water Soluble Carboxylic Acid Copolymer (p-1)

After methacrylic acid 60 g, methoxy poly (with 23 oxyethylene units, hereinafter indicated as n=23)ethylene glycol methacylate 300 g, sodium methallyl sulfonate 5 g, 3-mercapto propionic acid 4 g and water 490 g were placed in a reaction vessel, 48% aqueous solution of sodium hydroxide 58 g was added with stirring to uniformly dissolve for partial neutralization. After the atmosphere inside the reaction vessel was replaced with nitrogen, the temperature of the reaction system was maintained at 60° C. by means of a hot water bath, and a radical polymerization reaction was started by adding 20% aqueous solution of sodium persulfate 25 g and was finished after continuing for 5 hours. The reaction products were thereafter completely neutralized by adding 48% aqueous solution of sodium hydroxide 23 g and 40% aqueous solution of water soluble carboxylic acid copolymer (p-1) of polycarboxylic acid having structural units formed of methacrylic acid salts. Water soluble carboxylic acid copolymer (p-1) was analyzed and was discovered to be water soluble carboxylic acid copolymer with mass average molecular weight of 33800 having structural units formed of sodium methacrylate, structural units formed of methoxy poly(n=23)ethylene glycol methacrylate and structural units formed of sodium methallyl sulfonic acid at the rate of 70/27/3 (molar %).

Synthesis of Water Soluble Carboxylic Acid Copolymers (p-2)-(p-4) and (pr-1)-(pr-4)

Water soluble carboxylic acid copolymers (p-2)-(p-4) and (pr-1)-(pr-4) were similarly synthesized as water soluble carboxylic acid copolymer (p-1). Details of the water soluble carboxylic acid copolymers above are shown in Table 1.

TABLE 1

| Kind of | Ratio of each structural unit (molar %) | | | | | | | | Mass |
|---|---|---|---|---|---|---|---|---|---|
| water soluble | Structural | | Structural | | | Structural | | | average |
| carboxylic acid | Unit A | | Unit B | | | Unit C | | | molecular |
| copolymer | A-1 | A-2 | B-1 | B-2 | B-3 | C-1 | C-2 | C-3 | weight |
| P-1 | 70 | | 27 | | | 3 | | | 33800 |
| P-2 | 62 | 5 | | | 32 | | 1 | | 27500 |
| P-3 | 74 | | | 18 | | 4 | | 4 | 9400 |
| P-4 | 70 | | 30 | | | | | | 36200 |
| Pr-1 | 87 | | 13 | | | | | | 42600 |
| Pr-2 | 25 | | 70 | | | 5 | | | 14700 |
| Pr-3 | 30 | | | 40 | | | 30 | | 25300 |
| Pr-4 | 70 | | 30 | | | | | | 87000 |

In Table 1: Structural Units A-C: Each structural unit shown in terms of the monomer of which it is formed
A-1: Sodium methacrylate
A-2: Methacrylic acid
B-1: Methoxy poly(n = 23)ethylene glycol methacrylate
B-2: Methoxy poly(n = 68)ethylene glycol methacrylate
B-3: Methoxy poly(n = 9)ethylene glycol methacrylate
C-1: Sodium methallyl sulfonate
C-2: Sodium allyl sulfonate
C-3: Methyl acrylate

### Part 2 (Preparation of Blast-Furnace Slag Compositions)

Blast-furnace slag fine particles, anhydrous gypsum and alkaline stimulants were mixed under the conditions shown in Table 2 to obtain blast-furnace slag compositions (S-1)-(S-10) and (R-1)-(R-10).

TABLE 2
Blast-furnace slag compositions

| | Mixture of blast-furnace slag fine | | | | | |
|---|---|---|---|---|---|---|
| | particles and anhydrous gypsum | | | | Kind and ratio of | |
| | (total 100 mass parts) | | | | alkaline stimulant added | |
| | Blast-furnace slag | | Anhydrous | | to 100 parts of the | |
| | fine particles | | gypsum | | mixture shown on the left | |
| Kind | Kind | Ratio (%) | Kind | Ratio (%) | Kind | Ratio (%) |
| S-1 | sg-1 | 83 | gp-1 | 17 | rc-1 | 0.6 |
| S-2 | sg-1 | 88 | gp-1 | 12 | rc-1 | 0.8 |
| S-3 | sg-1 | 90 | gp-1 | 10 | rc-1 | 1.0 |
| S-4 | sg-2 | 93 | gp-2 | 7 | rc-1 | 1.2 |
| S-5 | sg-2 | 92 | gp-2 | 8 | rc-2 | 1.3 |
| S-6 | sg-1 | 83 | gp-1 | 17 | rc-1 | 7 |
| S-7 | sg-1 | 88 | gp-1 | 12 | rc-1 | 12 |
| S-8 | sg-1 | 90 | gp-1 | 10 | rc-2 | 20 |
| S-9 | sg-2 | 93 | gp-2 | 7 | rc-2 | 30 |
| S-10 | sg-2 | 92 | gp-2 | 8 | rc-1 | 40 |
| R-1 | sg-1 | 72 | gp-1 | 28 | rc-1 | 0.6 |
| R-2 | sg-1 | 98 | gp-1 | 2 | rc-1 | 0.6 |
| R-3 | sg-1 | 83 | gp-1 | 17 | rc-1 | 0.2 |
| R-4 | sg-1 | 83 | gp-1 | 17 | rc-1 | 2.1 |
| R-5 | sg-1 | 83 | gp-1 | 17 | rc-1 | 3.0 |
| R-6 | sg-1 | 83 | gp-1 | 17 | rc-1 | 4.0 |
| R-7 | sg-1 | 83 | gp-1 | 17 | rc-1 | 4.5 |
| R-8 | sg-1 | 83 | gp-1 | 17 | rc-1 | 50 |
| R-9 | sg-2 | 72 | gp-2 | 28 | rc-2 | 0.6 |
| R-10 | sg-3 | 83 | gp-1 | 17 | rc-1 | 0.6 |

In Table 2:
sg-1: Blast-furnace slag fine particles with fineness 4100 cm²/g
sg-2: Blast-furnace slag fine particles with fineness 5900 cm²/g
sg-3: Blast-furnace slag fine particles with fineness 1020 cm²/g
gp-1: Anhydrous gypsum with fineness 4150 cm²/g
gp-2: Anhydrous gypsum with fineness 5800 cm²/g
rc-1: Normal portland cement
rc-2: High early strength portland cement

### Part 3 (Preparation of Concrete Compositions)

### TEST EXAMPLES 1-36

Specified amounts of kneading water (faucet water), blast-furnace slag compositions and fine aggregates (Ooi-gawa River sand with density=2.58 g/cm³) were placed in a forced mixing pan-type mixer of 50 liters under conditions shown in Table 3 and specified amounts of admixtures such as cement dispersant, drying shrinkage reducing agent and expansion material, as well as an air content adjusting agent (AE-300 (tradename) produced by Takemoto Yushi Kabushiki Kaisha), were also placed inside to be kneaded together for 45 seconds. Finally, a specified amount of coarse aggregates (crushed stones from Okazaki with density=2.68 g/cm³) was placed inside and kneaded together for 60 seconds to prepare concrete compositions with target slump 18±1 cm, target air content 4.5±1% and mass ratio between water and blast-furnace slag composition 45% or 40%.

### COMPARISION EXAMPLES 1-27

Concrete compositions with mass ratio between water and blast-furnace slag composition 45% were prepared under the conditions shown in Table 4 and by a kneading method similar to that used in Test Examples.

### COMPARISON EXAMPLES 28 and 29

Concrete compositions using Type B blast-furnace cement with mass ratio between water and blast-furnace cement 45% or 50% were prepared under the conditions shown in Table 4 and by a kneading method similar to that used in Test Examples.

TABLE 3

| | | | Admixtures | | | Unit quantity (kg/m³) | | | |
|---|---|---|---|---|---|---|---|---|---|
| | Mass ratio | | | Drying | | Blast- | | | |
| | water/blast- | Carbon | Cement | shrinkage | Expansion | furnace slag | | | |
| | furnace slag | dioxide | dispersant | reducing agent | material | composition | | | |
| | composition | discharge | Kind/Used | Kind/Used | Kind/Used | Kind/Used | | | |
| | (%) | (kg) | amount | amount | amount | amount | Water | FA | CA |
| TE-1 | 45 | 1 | p-1/0.21 | *1/2.0 | — | S-1/355 | 160 | 815 | 963 |
| TE-2 | 45 | 2 | p-1/0.21 | *1/2.0 | — | S-2/355 | 160 | 815 | 963 |
| TE-3 | 45 | 3 | p-1/0.21 | *1/2.0 | — | S-3/355 | 160 | 815 | 963 |
| TE-4 | 45 | 3 | p-1/0.21 | *1/2.0 | — | S-4/355 | 160 | 815 | 963 |
| TE-5 | 45 | 4 | p-1/0.22 | *1/2.0 | — | S-5/355 | 160 | 815 | 963 |
| TE-6 | 45 | 18 | p-1/0.22 | *1/2.0 | — | S-6/355 | 160 | 815 | 963 |
| TE-7 | 45 | 30 | p-1/0.23 | *1/2.0 | — | S-7/355 | 160 | 815 | 963 |
| TE-8 | 45 | 47 | p-1/0.23 | *1/2.0 | — | S-8/355 | 160 | 815 | 963 |
| TE-9 | 45 | 65 | p-1/0.24 | *1/2.0 | — | S-9/355 | 160 | 815 | 963 |
| TE-10 | 45 | 81 | p-1/0.22 | *1/2.0 | — | S-10/355 | 160 | 815 | 963 |
| TE-11 | 45 | 1 | p-1/0.21 | *2/2.0 | — | S-1/355 | 160 | 815 | 963 |
| TE-12 | 45 | 3 | p-2/0.23 | *2/2.0 | — | S-3/355 | 160 | 815 | 963 |
| TE-13 | 45 | 3 | p-3/0.20 | *2/2.0 | — | S-4/355 | 160 | 815 | 963 |
| TE-14 | 45 | 4 | p-4/0.22 | *2/2.0 | — | S-5/355 | 160 | 815 | 963 |
| TE-15 | 45 | 18 | p-1/0.22 | *2/2.0 | — | S-6/355 | 160 | 815 | 963 |
| TE-16 | 45 | 30 | p-2/0.23 | *2/2.0 | — | S-7/355 | 160 | 815 | 963 |
| TE-17 | 45 | 47 | p-3/0.24 | *2/2.0 | — | S-8/355 | 160 | 815 | 963 |
| TE-18 | 45 | 26 | p-4/0.22 | *2/2.0 | — | S-10/355 | 160 | 815 | 963 |
| TE-19 | 45 | 1 | p-1/0.25 | — | *3/20 | S-1/335 | 160 | 815 | 963 |
| TE-20 | 45 | 3 | p-3/0.26 | — | *3/20 | S-3/335 | 160 | 815 | 963 |
| TE-21 | 45 | 4 | p-4/0.24 | — | *3/15 | S-5/340 | 160 | 815 | 963 |
| TE-22 | 45 | 18 | p-1/0.25 | — | *3/20 | S-6/335 | 160 | 815 | 963 |
| TE-23 | 45 | 30 | p-3/0.25 | — | *3/20 | S-7/335 | 160 | 815 | 963 |
| TE-24 | 45 | 47 | p-4/0.26 | — | *3/15 | S-8/340 | 160 | 815 | 963 |
| TE-25 | 40 | 1 | p-1/0.30 | *1/1.5 | — | S-1/387 | 155 | 777 | 984 |
| TE-26 | 40 | 3 | p-3/0.30 | *1/1.5 | — | S-3/387 | 155 | 777 | 984 |
| TE-27 | 40 | 4 | p-4/0.31 | *2/1.5 | — | S-5/387 | 155 | 777 | 984 |
| TE-28 | 40 | 20 | p-1/0.32 | *1/1.5 | — | S-6/387 | 155 | 777 | 984 |
| TE-29 | 40 | 33 | p-3/0.32 | *1/1.5 | — | S-7/387 | 155 | 777 | 984 |
| TE-30 | 40 | 51 | p-4/0.34 | *2/1.5 | — | S-8/387 | 155 | 777 | 984 |
| TE-31 | 45 | 1 | p-5/0.23 | *1/2.0 | — | S-1/355 | 160 | 815 | 963 |
| TE-32 | 45 | 3 | p-5/0.23 | *2/2.0 | — | S-4/355 | 160 | 815 | 963 |
| TE-33 | 45 | 18 | p-5/0.24 | *1/2.0 | — | S-6/355 | 160 | 815 | 963 |
| TE-34 | 45 | 81 | p-5/0.24 | *2/2.0 | — | S-10/355 | 160 | 815 | 963 |
| TE-35 | 40 | 1 | p-5/0.33 | *1/1.5 | — | S-1/387 | 155 | 777 | 984 |
| TE-36 | 40 | 20 | p-5/0.33 | *1/1.5 | — | S-6/387 | 155 | 777 | 984 |

TABLE 4

| | | | Admixtures | | | Unit quantity (kg/m³) | | | |
|---|---|---|---|---|---|---|---|---|---|
| | Mass ratio | | | Drying | | Blast- | | | |
| | water/blast- | Carbon | Cement | shrinkage | Expansion | furnace slag | | | |
| | furnace slag | dioxide | dispersant | reducing agent | material | composition | | | |
| | composition | discharge | Kind/Used | Kind/Used | Kind/Used | Kind/Used | | | |
| | (%) | (kg) | amount | amount | amount | amount | Water | FA | CA |
| CE-1 | 45 | 3 | — | *1/2.0 | — | S-3/355 | 160 | 815 | 963 |
| CE-2 | 45 | 3 | — | — | *3/20 | S-3/335 | 160 | 815 | 963 |
| CE-3 | 45 | 1 | p-3/0.20 | — | — | S-1/355 | 160 | 815 | 963 |
| CE-4 | 45 | 4 | p-4/0.22 | — | — | S-5/355 | 160 | 815 | 963 |
| CE-5 | 45 | 30 | p-1/0.23 | — | — | S-7/355 | 160 | 815 | 963 |
| CE-6 | 45 | 30 | — | *1/2.0 | — | S-7/355 | 160 | 815 | 963 |
| CE-7 | 45 | 30 | — | — | *3/20 | S-7/335 | 160 | 815 | 963 |
| CE-8 | 45 | 18 | p-3/0.21 | — | — | S-6/355 | 160 | 815 | 963 |
| CE-9 | 45 | 47 | p-4/0.24 | — | — | S-8/355 | 160 | 815 | 963 |
| CE-10 | 45 | 3 | p-1/0.21 | *1/2.0 | — | R-1/355 | 160 | 815 | 963 |
| CE-11 | 45 | 3 | p-1/0.21 | *1/2.0 | — | R-2/355 | 160 | 815 | 963 |
| CE-12 | 45 | 1 | p-1/0.21 | *1/2.0 | — | R-3/355 | 160 | 815 | 963 |
| CE-13 | 45 | 6 | p-1/0.21 | *1/2.0 | — | R-4/355 | 160 | 815 | 963 |
| CE-14 | 45 | 8 | p-1/0.21 | *1/2.0 | — | R-5/355 | 160 | 815 | 963 |
| CE-15 | 45 | 11 | p-1/0.21 | *1/2.0 | — | R-6/355 | 160 | 815 | 963 |
| CE-16 | 45 | 12 | p-1/0.21 | *1/2.0 | — | R-7/355 | 160 | 815 | 963 |
| CE-17 | 45 | 95 | p-1/0.23 | *1/2.0 | — | R-8/355 | 160 | 815 | 963 |
| CE-18 | 45 | 1 | p-1/0.22 | *1/2.0 | — | R-9/355 | 160 | 815 | 963 |
| CE-19 | 45 | 1 | p-1/0.21 | *1/2.0 | — | R-10/355 | 160 | 815 | 963 |
| CE-20 | 45 | 3 | pr-1/0.25 | *1/2.0 | — | S-3/355 | 160 | 815 | 963 |
| CE-21 | 45 | 3 | pr-2/0.30 | *2/2.0 | — | S-3/355 | 160 | 815 | 963 |
| CE-22 | 45 | 3 | pr-3/0.30 | *1/2.0 | — | S-3/355 | 160 | 815 | 963 |
| CE-23 | 45 | 3 | pr-4/0.30 | *2/2.0 | — | S-3/355 | 160 | 815 | 963 |
| CE-24 | 45 | 30 | pr-1/0.26 | *1/2.0 | — | S-7/355 | 160 | 815 | 963 |
| CE-25 | 45 | 30 | pr-2/0.30 | *2/2.0 | — | S-7/355 | 160 | 815 | 963 |
| CE-26 | 45 | 30 | pr-3/0.30 | *1/2.0 | — | S-7/355 | 160 | 815 | 963 |
| CE-27 | 45 | 30 | pr-4/0.30 | *2/2.0 | — | S-7/355 | 160 | 815 | 963 |
| CE-28 | 45 | 142 | p-1/0.22 | — | — | *4/355 | 160 | 815 | 963 |
| CE-29 | 50 | 128 | p-1/0.20 | — | — | *4/320 | 160 | 875 | 941 |

In Tables 3 and 4:
TE: Test Example
CE: Comparison Example
FA: Fine aggregates
CA: Coarse aggregates
Carbon dioxide discharge: Amount of carbon dioxide discharged in kg for producing 1 m³ of concrete composition, as calculated from the amount of used portland cement by excluding the discharged amount of carbon dioxide originating from energy required for production of gypsum
Kind of cement dispersant: Water soluble carboxylic acid copolymer shown in Table 1 or P-5 shown below
P-5: Chupol HP-11W (tradename) produced by Takemoto Yushi Kabushiki Kaisha (copolymer salt of maleic acid and α-aryl-ω-methyl-polyoxyethylene) as cement dispersant comprising water soluble carboxylic acid copolymer
Used Amount: Mass part as solid portion of cement dispersant, drying shrinkage reducing agent or expansion material per 100 mass part of blast-furnace slag composition (Type B blast-furnace cement for Comparison Examples 28 and 29)
Kind of Blast-furnace slag composition: As shown in Table 2
*1: Diethylene glycol monobutylether
*2: Dipropylene glycol diethylene glycol monobutylether
*3: Taiheiyo HYPER EXPAN (tradename) produced by Taiheiyo Materials Corporation (lime-type expansion material)
*4: Type B blast-furnace cement with density = 3.04 g/cm³, blain value = 3850 cm²/g)

### Part 4 (Evaluation of Prepared Concrete Compositions)

For each example of concrete compositions that were prepared, air content, slump and slump loss were obtained as explained below. Drying shrinkage ratio and compressive strength of hardened objects obtained from each concrete composition were also obtained as explained below.

### Air Content (Volume %)

Measurements were taken according to JIS-A1128 on concrete compositions immediately after the kneading and after being left for 60 minutes.

### Slump (cm)

This was measured according to JIS-A1101 simultaneously with the measurement of the air content.

### Slump Loss (%)

This was obtained as {(Slump after being left quietly for 60 minutes)/(Slump immediately after kneading)}×100.

### Drying Shrinkage Ratio (%)

This was obtained according to JIS-Al 129 by measuring the drying shrinkage strain on a sample at material age of 26 weeks, kept under the condition of 20° C.×60% RH for each example of concrete compositions by the comparator method. The smaller the value of this rate, the smaller is the drying shrinkage.

### Compressive Strength (N/mm²)

Measurements were made according to JIS-A1108 for each example of concrete compositions at material ages of 7 days and 28 ages.

The results are shown in Tables 5 and 6. It is clearly seen for each of concrete compositions prepared in Test Examples according to this invention that less carbon dioxide is discharged for the production of 1 m³ of the concrete composition than if Type B blast-furnace slag cement is used, that the fluidity of the concrete composition is superior over time, that the drying shrinkage ratio of objects obtained thereof is smaller than 800×10⁻⁶ and that required compressive strength is sufficiently obtained.

TABLE 5

| | Concrete composition | | | | | Hardened object | | |
|---|---|---|---|---|---|---|---|---|
| | Immediately after | | 60 minutes | | | Drying | Compressive strength | |
| | kneading | | after | | | shrinkage ratio | (N/mm²) | |
| | | Air | | Air | | (Material | Material | Material |
| | Slump | content | Slump | content | Slump | age = 26 weeks) | age = 7 | age = 28 |
| | (cm) | % | (cm) | % | loss (%) | (×10⁻⁶) | days | days |
| TE-1 | 18.6 | 4.4 | 16.9 | 4.2 | 90.9 | 716 | 15.8 | 40.7 |
| TE-2 | 18.5 | 4.5 | 17.0 | 4.3 | 91.9 | 715 | 15.9 | 40.8 |
| TE-3 | 18.4 | 4.3 | 16.8 | 4.3 | 91.3 | 717 | 16.0 | 41.2 |
| TE-4 | 18.2 | 4.6 | 16.9 | 4.3 | 92.8 | 720 | 16.3 | 41.0 |
| TE-5 | 18.3 | 4.3 | 16.5 | 4.1 | 90.2 | 720 | 16.8 | 41.2 |
| TE-6 | 18.7 | 4.4 | 16.4 | 4.1 | 87.7 | 728 | 16.6 | 41.4 |
| TE-7 | 18.6 | 4.6 | 16.2 | 4.3 | 87.1 | 726 | 16.7 | 41.7 |
| TE-8 | 18.9 | 4.6 | 15.8 | 4.2 | 83.6 | 733 | 16.9 | 41.9 |
| TE-9 | 18.7 | 4.4 | 15.5 | 4.0 | 82.9 | 740 | 17.2 | 42.1 |
| TE-10 | 18.4 | 4.5 | 16.5 | 4.1 | 89.7 | 725 | 17.9 | 43.0 |
| TE-11 | 18.4 | 4.3 | 17.0 | 4.2 | 92.4 | 720 | 15.6 | 40.6 |
| TE-12 | 18.5 | 4.6 | 16.7 | 4.3 | 90.2 | 722 | 16.1 | 41.3 |
| TE-13 | 18.7 | 4.5 | 15.5 | 4.2 | 82.9 | 719 | 15.7 | 40.6 |
| TE-14 | 18.4 | 4.7 | 15.8 | 4.3 | 95.9 | 720 | 15.9 | 40.9 |
| TE-15 | 18.5 | 4.5 | 16.7 | 4.3 | 90.2 | 725 | 16.0 | 41.0 |
| TE-16 | 18.7 | 4.6 | 15.3 | 4.2 | 81.8 | 725 | 16.3 | 40.9 |
| TE-17 | 18.4 | 4.4 | 15.5 | 4.1 | 84.2 | 731 | 16.5 | 41.4 |
| TE-18 | 18.6 | 4.6 | 15.7 | 4.3 | 84.4 | 726 | 17.7 | 42.8 |
| TE-19 | 18.7 | 4.3 | 16.1 | 4.0 | 86.1 | 712 | 16.0 | 40.9 |
| TE-20 | 18.5 | 4.6 | 15.7 | 4.2 | 84.9 | 710 | 16.2 | 41.1 |
| TE-21 | 18.3 | 4.5 | 15.4 | 4.1 | 84.1 | 730 | 16.8 | 41.7 |
| TE-22 | 18.6 | 4.7 | 16.2 | 4.3 | 87.1 | 712 | 17.0 | 42.0 |
| TE-23 | 18.4 | 4.4 | 15.3 | 4.0 | 83.2 | 714 | 17.3 | 42.5 |
| TE-24 | 18.2 | 4.6 | 15.0 | 4.2 | 82.4 | 735 | 17.4 | 42.8 |
| TE-25 | 18.5 | 4.8 | 17.0 | 4.4 | 91.9 | 708 | 18.6 | 45.7 |
| TE-26 | 18.7 | 4.5 | 17.2 | 4.2 | 92.0 | 710 | 18.4 | 45.5 |
| TE-27 | 18.8 | 4.7 | 17.4 | 4.3 | 92.6 | 712 | 18.6 | 45.8 |
| TE-28 | 18.6 | 4.4 | 17.1 | 4.1 | 91.9 | 709 | 18.8 | 45.9 |
| TE-29 | 18.5 | 4.6 | 17.2 | 4.4 | 93.0 | 715 | 18.9 | 46.1 |
| TE-30 | 18.3 | 4.5 | 17.0 | 4.3 | 92.9 | 722 | 19.0 | 46.4 |
| TE-31 | 18.8 | 4.6 | 16.0 | 4.2 | 85.1 | 721 | 15.0 | 39.8 |
| TE-32 | 18.5 | 4.8 | 15.9 | 4.4 | 85.9 | 726 | 15.5 | 40.2 |
| TE-33 | 18.7 | 4.6 | 15.7 | 4.1 | 83.9 | 731 | 15.7 | 40.4 |
| TE-34 | 18.5 | 4.7 | 15.6 | 4.2 | 84.3 | 728 | 17.4 | 42.5 |
| TE-35 | 18.6 | 4.5 | 16.0 | 4.1 | 86.0 | 712 | 17.3 | 42.9 |
| TE-36 | 18.4 | 4.7 | 15.9 | 4.2 | 86.4 | 714 | 17.1 | 42.7 |

TABLE 6

| | Concrete composition | | | | | Hardened object | | |
|---|---|---|---|---|---|---|---|---|
| | Immediately after | | 60 minutes | | | Drying | Compressive strength | |
| | kneading | | after | | | shrinkage ratio | (N/mm²) | |
| | | Air | | Air | | (Material | Material | Material |
| | Slump | content | Slump | content | Slump | age = 26 weeks) | age = 7 | age = 28 |
| | (cm) | % | (cm) | % | loss (%) | (×10⁻⁶) | days | days |
| CE-1 | — | — | — | — | — | — | — | — |
| CE-2 | — | — | — | — | — | — | — | — |
| CE-3 | 18.4 | 4.5 | 13.1 | 4.0 | 71.2 | 832 | 15.7 | 40.6 |
| CE-4 | 18.5 | 4.4 | 12.7 | 3.9 | 68.6 | 836 | 15.3 | 40.2 |
| CE-5 | 18.3 | 4.7 | 12.2 | 4.1 | 66.7 | 840 | 15.9 | 40.8 |
| CE-6 | — | — | — | — | — | — | — | — |
| CE-7 | — | — | — | — | — | — | — | — |
| CE-8 | 18.7 | 4.6 | 12.8 | 4.0 | 68.4 | 835 | 15.2 | 40.0 |
| CE-9 | 18.5 | 4.8 | 12.5 | 3.9 | 67.6 | 840 | 15.3 | 40.3 |
| CE-10 | 18.3 | 4.5 | 13.0 | 4.1 | 71.0 | 740 | 5.9 | 22.6 |
| CE-11 | 18.6 | 4.7 | 13.2 | 4.3 | 70.9 | 755 | 2.2 | 15.5 |
| CE-12 | 18.8 | 4.4 | 14.0 | 4.0 | 74.4 | 728 | 0.8 | 7.3 |
| CE-13 | 18.7 | 4.6 | 12.8 | 4.2 | 68.4 | 733 | 3.7 | 19.0 |
| CE-14 | 18.5 | 4.5 | 12.6 | 4.0 | 68.1 | 735 | 1.4 | 12.6 |
| CE-15 | 18.8 | 4.8 | 12.9 | 4.3 | 68.6 | 740 | 3.5 | 18.4 |
| CE-16 | 18.3 | 4.4 | 12.4 | 4.0 | 67.8 | 741 | 4.0 | 20.3 |
| CE-17 | 18.6 | 4.7 | 12.0 | 4.1 | 64.5 | 743 | 12.5 | 34.8 |
| CE-18 | 18.4 | 4.8 | 13.0 | 4.5 | 70.6 | 736 | 6.6 | 23.5 |
| CE-19 | 18.8 | 4.5 | 13.2 | 4.0 | 70.2 | 742 | 4.8 | 21.2 |
| CE-20 | 18.5 | 4.7 | 11.4 | 4.0 | 61.6 | 724 | 15.3 | 40.2 |
| CE-21 | — | — | — | — | — | — | — | — |
| CE-22 | — | — | — | — | — | — | — | — |
| CE-23 | — | — | — | — | — | — | — | — |
| CE-24 | 18.7 | 4.6 | 12.1 | 4.1 | 64.7 | 720 | 15.5 | 40.4 |
| CE-25 | — | — | — | — | — | — | — | — |
| CE-26 | — | — | — | — | — | — | — | — |
| CE-27 | — | — | — | — | — | — | — | — |
| CE-28 | 18.2 | 4.7 | 8.5 | 3.7 | 46.7 | 785 | 17.9 | 41.7 |
| CE-29 | 18.5 | 4.5 | 9.0 | 4.0 | 48.6 | 818 | 16.2 | 36.4 |

In Table 6: Measurements were not taken on Comparison Examples 1, 2, 6, 7, 21-23 and 25-27 because target fluidity (slump) was not obtained.

What is claimed is:

1. A concrete composition comprising a binder, water, a fine aggregate, a coarse aggregate and an admixture, said binder comprising a blast-furnace slag composition comprising 100 mass parts of a mixture consisting of 80-95 mass % of blast-furnace slag fine particles with fineness 3000-13000 cm²/g and 5-20 mass parts of gypsum for a total of 100 mass % and 0.5-1.5 mass parts or 5-45 mass parts of an alkaline stimulant.

2. The concrete composition of claim 1 wherein said alkaline stimulant comprises portland cement.

3. The concrete composition of claim 2 wherein said gypsum is anhydrous gypsum.

4. The concrete composition of claim 3 wherein the fineness of said blast-furnace slag fine particles is 3500-6500 cm²/g.

5. The concrete composition of claim 4 wherein at least a portion of said admixture includes a cement dispersant comprising water soluble polycarboxylic acid copolymer at a rate of 0.1-1.5 mass parts per 100 mass parts of said blast-furnace slag composition.

6. The concrete composition of claim 5 wherein said water soluble polycarboxylic acid copolymer has in its molecules 45-80 molar % of Structural Units A, 15-55 molar % of Structural Units B and 0-10 molar % of Structural Units C for a total of 100 molar % and has a mass average molecular weight of 2000-80000;
Structural Units A being one or more selected from structural units formed of methacrylic acid and structural units formed of salts of methacrylic acid;
Structural Units B being structural units formed of methoxy polyethylene glycol methacrylate having polyoxy ethylene group having 5-150 oxyethylene units within a molecule; and
Structural Units C being one or more selected from structural units formed of (meth)allyl sulfonic acid and structural units formed of methyl acrylate.

7. The concrete composition of claim 5 wherein at least a portion of said admixture includes a drying shrinkage reducing agent comprising polyalkylene glycol monoalkylether at a rate of 0.2-4.0 mass parts per 100 mass parts of said blast-furnace slag composition.

8. The concrete composition of claim 7 wherein said drying shrinkage reducing agent comprises one or more selected from diethylene glycol monobutylether and dipropylene glycol diethtylene glycol monobutylether.

9. The concrete composition of claim 5 wherein at least a portion of said admixture includes an expansion material at a rate of 10-25 kg per 1 m³ of said concrete composition.

10. The concrete composition of claim 7 wherein said water and said blast-furnace slag composition are prepared at a mass ratio of 35-55%.

11. The concrete composition of claim 9 wherein said water and said blast-furnace slag composition are prepared at a mass ratio of 35-55%.

12. The concrete composition of claim 10 from which hardened objects with drying shrinkage ratio less than 800×10⁻⁶ are obtained.

13. The concrete composition of claim 11 from which hardened objects with drying shrinkage ratio less than 800×10⁻⁶ are obtained.
